(19) United States
(12) Patent Application Publication
(10) Pub. No.: US 2016/0286174 A1
(43) Pub. Date: Sep. 29, 2016

(54) DISPLAY DEVICE, INFORMATION PROCESSOR, AND IMAGE PROCESSING METHOD

(71) Applicant: Kabushiki Kaisha Toshiba, Tokyo (JP)

(72) Inventors: Reiko NODA, Kawasaki Kanagawa (JP); Masahiro BABA, Yokohama Kanagawa (JP); Yoshiyuki KOKOJIMA, Yokohama Kanagawa (JP)

(21) Appl. No.: 14/945,330

(22) Filed: Nov. 18, 2015

(30) Foreign Application Priority Data
Mar. 24, 2015 (JP) 2015-061377

(51) Int. Cl. H04N 7/18; G02B 27/01; G09G 3/34

(52) U.S. Cl. CPC H04N 7/185; G09G 3/3413; G02B 27/0172; G02B 2027/014; G02B 2027/0141; G02B 2027/0118; G02B 2027/0112

(57) ABSTRACT

According to one embodiment, a display device to be mounted on a head of a user, includes a display, a reflector, and a processor. The display is configured to emit image light including information of an image. The reflector is configured to reflect at least a part of the image light toward an eye of the user. The reflector is semi-transmissive. The processor is configured to control the display so as to reduce visibility of at least a part of the image when the processor receives a first signal while the display is emitting the image light. The first signal represents an action of the user in use.

### CROSS-REFERENCE TO RELATED APPLICATIONS

This application is based upon and claims the benefit of priority from Japanese Patent Application No. 2015-061377, filed on Mar. 24, 2015; the entire contents of which are incorporated herein by reference.

### FIELD

Embodiments described herein relate generally to a display device, an information processor, and an image processing method.

### BACKGROUND

Work efficiency can be increased by providing a worker with information relating to the work by using an eyeglasses-type or head mounted see-through type display. It is desirable for a display device that uses such a display or an information processor included in the display device to provide easily-viewable information relating to the work and to further increase the efficiency of the work.

### BRIEF DESCRIPTION OF THE DRAWINGS

FIG. 1 is a block diagram showing a display device according to the embodiment;

FIG. 2 is a schematic view showing the display device according to the embodiment;

FIG. 3 is a flowchart showing the processing of the display device according to the embodiment;

FIG. 4 is a flowchart showing the processing of the display device according to the embodiment;

FIG. 5A to FIG. 5E are schematic views showing the image displayed by the display device according to the embodiment;

FIG. 6A to FIG. 6C are schematic views showing the image displayed by the display device according to the embodiment;

FIG. 7A to FIG. 7G are schematic views showing the image displayed by the display device according to the embodiment; and

FIG. 8 is a flowchart showing the processing of the display device according to the embodiment.

### DETAILED DESCRIPTION

According to one embodiment, a display device to be mounted on a head of a user, includes a display, a reflector, and a processor. The display is configured to emit image light including information of an image. The reflector is configured to reflect at least a part of the image light toward an eye of the user. The reflector is semi-transmissive. The processor is configured to control the display so as to reduce visibility of at least a part of the image when the processor receives a first signal while the display is emitting the image light. The first signal represents an action of the user in use.

According to one embodiment, an information processor includes a signal processor and a display controller. The display controller is configured to control a display so as to reduce visibility of at least a part of an image when the signal processor receives a first signal while the display of a display device is emitting image light including information of the image. The display device is mountable to a head of a user and including the display and a reflector to reflect at least a part of the image light toward an eye of the user, the reflector is semi-transmissive. The first signal represents an action of the user in use.

According to one embodiment, an image processing method includes receiving a first signal while a display of a display device is emitting image light including information of an image. The display device is mountable to a head of a user and includes the display and a reflector to reflect at least a part of the image light toward an eye of the user. The reflector is semi-transmissive. The first signal represents an action of the user in use. The method includes controlling the display so as to reduce visibility of at least a part of the image when the first signal is received.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

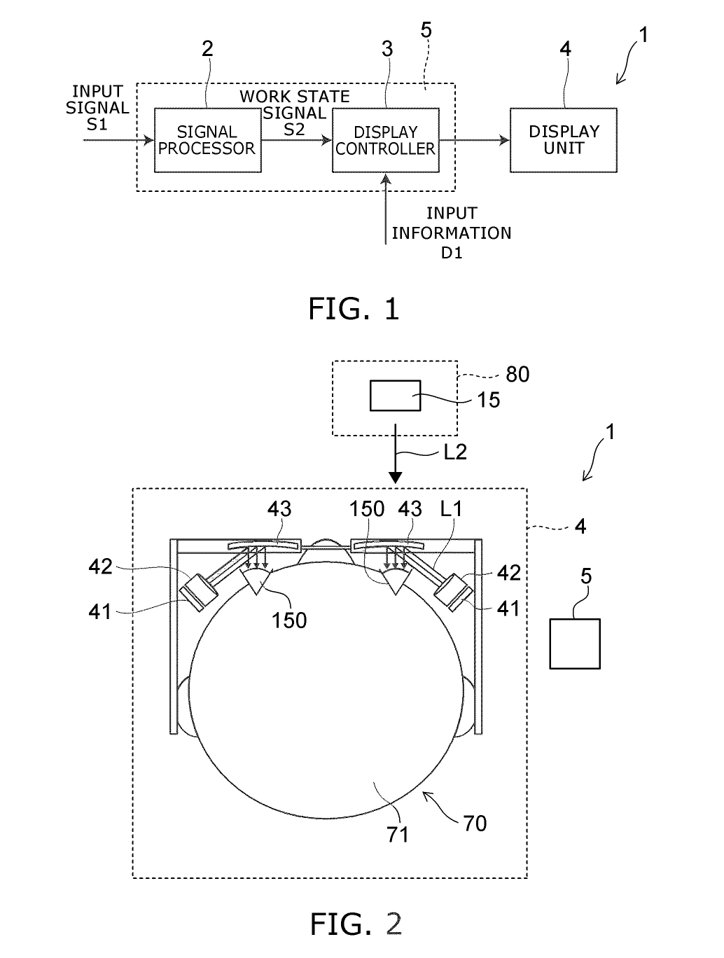

FIG. 1 is a block diagram illustrating a display device according to the embodiment.

FIG. 2 is a schematic view illustrating the display device according to the embodiment.

As shown in FIG. 1 and FIG. 2, the display device 1 according to the embodiment includes a display unit 4 and an information processor 5. The display unit 4 is, for example, a see-through type head mounted display device. The display device 1 is, for example, a head mounted information display system to be mounted on a head of a user.

As shown in FIG. 1, the information processor 5 includes a signal processor 2 and a display controller 3. As shown in FIG. 2, for example, the information processor 5 is connected to an external device 15 by a wired or wireless method.

For example, the signal processor 2 receives an input signal S1 (a first signal) from the external device 15, etc. The signal processor 2 processes the input signal S1 that is obtained and converts the input signal S1 into a work state signal S2. The work state signal S2 indicates the state of work (an action of the user) performed by a user 70 wearing the display unit 4. The signal processor 2 passes the work state signal S2 to the display controller 3.

The display controller 3 controls the operation of the display unit 4. Input information D1 is input to the display controller 3. The display unit 4 displays an image based on the input information D1 input to the display controller 3. The display controller 3 controls the image displayed by the display unit 4 based on the input information D1 that is input and the work state signal S2 obtained from the signal processor 2. For example, the display controller 3 controls the ON and OFF (the display and the non-display) of the image displayed by the display unit 4. Or, the display controller 3 controls the display position, display luminance, display content, contrast, color, etc., of the image displayed by the display unit 4.

Based on the control of the display controller 3, the display unit 4 performs the display of the image controlled by the display controller 3; or the display unit 4 performs the non-display of the image controlled by the display controller 3.

For example, the signal processor 2 and the display controller 3 may be provided as an electronic circuit inside the head mounted display unit 4, etc. The display device 1 according to the embodiment may be a system in which portions of the signal processor 2 and the display controller 3 are contained inside the head mounted display unit 4; and the other portions of the signal processor 2 and the display controller 3 are provided as separate devices and wired or wireless communications are performed.

The signal processor 2 and the display controller 3 will now be described further.

The work that is performed by the user 70 is, for example, the work of reading information of an object. Specifically, the work is the scanning of a one-dimensional code (a barcode), a two-dimensional code, a RFID (radio frequency identifier), OCR (optical character recognition), characters, etc.

In such a case, for example, the external device 15 that is connected to the signal processor 2 is a reader for reading the one-dimensional code, the two-dimensional code, the RFID, the OCR, the characters, etc. The signal processor 2 analyzes as input the signal transmitted from the reader held by the user 70 and converts the input into the work state signal S2 indicating the work state of the user 70.

For example, the external device 15 that is connected to the signal processor 2 may be a camera that is mounted in the display device 1 or mounted separately on a portion of the body of the user 70. In such a case, the signal processor 2 analyzes as input the image from the camera and converts the input into the work state signal S2 indicating the work state of the user 70.

For example, the external device 15 that is connected to the signal processor 2 may be a microphone that is mounted in the display device 1 or mounted separately on a portion of the body of the user 70. In such a case, the signal processor 2 analyzes as input the voice from the microphone and converts the input into the work state signal S2 indicating the work state of the user 70.

The external device 15 that is connected to the signal processor 2 may be a personal digital assistant such as a smartphone, etc., or an operation device such as a mouse, a keyboard, a touch panel, a switch, etc. The signal processor 2 may receive as input the signal transmitted from the personal digital assistant or the operation device and modify the input into the work state signal S2.

If the work state of the user 70 can be recognized from the input signal S1 that is input to the signal processor 2, the input signal S1 may be a signal other than those described above. The connection between the external device 15 and the signal processor 2 may be wired or wireless. In other words, the signal input to the signal processor 2 may be input via a wired method or via a wireless method.

For example, when the user 70 performs barcode reading work, a signal that indicates that the barcode reader is in the read mode is input to the signal processor 2 from the reader. At this time, the signal processor 2 outputs a barcode reading start signal as the work state signal S2 indicating the work state.

For example, in the case where the work that is performed by the user 70 is the work of transmitting an image that is imaged by a camera to a worker at a remote location using a smartphone, etc., the user 70 initiates an application for the smartphone to transmit the image. In such a case, a signal that indicates to the signal processor 2 that the application has been initiated is input from the smartphone to the signal processor 2. At this time, the signal processor 2 outputs an image transfer work start signal as the work state signal S2.

For example, the work that is performed by the user 70 may be work that does not use an electronic device such as opening packaging materials using a cutter, etc. In such a case, for example, it can be detected that the package opening work, etc., has started by using an image signal from a camera that is mounted in the head mounted information display device 1 or mounted separately on a portion of the body of the user 70 as the input signal S1 of the signal processor 2 and performing the detection based on image recognition. The signal processor 2 may output the work state signal S2 indicating that the package opening work has started based on the image recognition.

For example, the user 70 may indicate the state of the work using a voice. In such a case, for example, the work state signal S2 that indicates the state of the work may be output by using a voice signal from a microphone that is mounted in the head mounted information display device 1 or mounted separately on a portion of the body of the user 70 as the input signal S1 of the signal processor 2 and by performing the output based on voice recognition.

Other than the examples described above, it is sufficient for the processing performed by the signal processor 2 to recognize the state of the work and output the work state signal S2 indicating the work state.

The display controller 3 controls the display based on the work state signal S2 output from the signal processor 2 and based on the input information D1 corresponding to the image that is input to the display controller 3 and displayed currently by the display unit 4.

The input information D1 includes information relating to the work of the user 70, e.g., information providing an instruction for the work content to the user 70. The input information D1 includes the information relating to the work indicated by the work state signal S2; and when the input information D1 is displayed by the display unit 4, the display controller 3 reduces the visibility of the display. Specific methods are described below.

For example, the input information D1 is pre-stored in a nonvolatile storage medium such as ROM, etc. In such a case, for example, the storage medium is pre-embedded inside the display device 1; and the input information D1 is read from the storage medium. Or, the input information D1 may be provided via a network such as the Internet, an intranet, etc.

The display unit 4 will now be described.

The display unit 4 is mounted to a head 71 of the user 70 and is a display device that can project an image displayed by a compact display toward an optical system in front the eye of the user to present the image to the user.

Display devices that are mountable to the head are broadly divided into the two types of a video see-through type and an optical see-through type. Here, the display unit 4 according to the embodiment is the latter, i.e., an optical see-through type. The optical see-through type often is compact but may be large. A monocular-type display device that displays information to only one eye and a binocular-type display device that displays information to both eyes exist; and either may be used as the display unit 4 according to the embodiment.

FIG. 2 shows a specific arrangement example of the components included in the display unit 4. In the example of FIG. 2, the display unit 4 is the binocular-type. However, the display unit 4 according to the embodiment is not limited thereto. As shown in FIG. 2, the display unit 4 includes a display 41, a projector 42, and a reflector 43 (reflective/transmissive unit).

The display 41 is a display device that displays an image. The display 41 includes, for example, a liquid crystal-type display device or an organic EL-type display device. Multiple pixels that emit light are provided in the display 41. The display 41 emits, from the multiple pixels, image light L1 including image information based on the input information D1. The image information includes the information relating to the work of the user 70. The image light L1 that is emitted from the display 41 is incident on the projector 42.

The projector 42 modifies the optical path and/or the position of the focal point of the image light L1 emitted from the pixels of the display 41 and projects the image light L1 toward the reflector 43. In the example, the projector 42 projects the image light L1 including the information of the image emitted from the display 41. The projector 42 includes, for example, multiple optical elements. The optical elements are, for example, lenses, prisms, or mirrors. These optical elements may not be arranged in a straight line.

For example, external light L2 from an external environment toward the head 71 is incident on the reflector 43, where the external environment is the region on the side of the reflector 43 opposite to an eye 150 of the user with the reflector 43 interposed between the eye 150 and the external environment. At least a part of the external light L2 that is incident on the reflector 43 passes through the reflector 43 to be incident on the head 71 (the eye 150). The external environment is, for example, a work space 80 where the user 70 performs the work. The reflector 43 reflects, toward the head 71 (the eye 150) of the user 70, at least a part of the image light L1 passing through the projector 42. The user 70 can view the image by at least a part of the image light L1 reflected by the reflector 43 being guided toward the eye 150 of the user. Thus, the image that corresponds to the image information included in the image light L1 is displayed by the display unit 4. The reflector 43 is semi-transmissive and may include, for example, a half mirror.

By using such a reflector 43, the external environment (the work space 80) and the image displayed by the display unit 4 (hereinbelow, called the “display image” for convenience of description) are included in the visual field of the user 70. When viewed by the user 70, for example, the display image is displayed so that the display image and the work space 80 overlap.

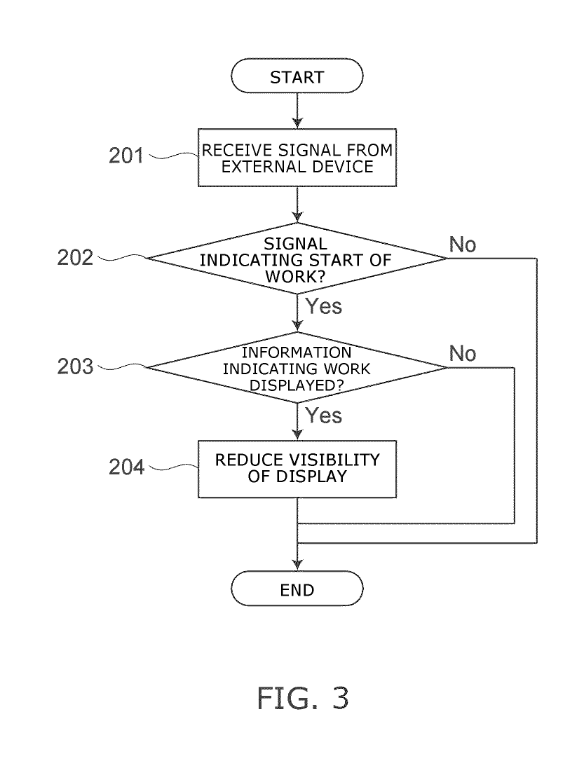

An example of processing performed by the signal processor 2 and the display controller 3 will now be described with reference to FIG. 3. FIG. 3 is a flowchart illustrating the processing of the display device according to the embodiment.

For example, in processing 201 at a first time, the signal processor 2 receives a signal from the external device 15.

Then, in processing 202, the signal processor 2 determines whether or not the signal received in the processing 201 is a signal relating to a subsequent (in a first interval after the first time) action of the user. For example, the signal processor 2 determines whether or not the signal received in the processing 201 is a signal indicating the start of the subsequent work (action) of the user 70. If the signal received in the processing 201 is not a signal indicating the work start, the signal processor 2 ends the processing. In the case where the signal received in the processing 201 is a signal indicating the work start, the signal processor 2 uses the received signal as the work state signal S2 and converts the received signal into the work start signal. Then, the signal processor 2 outputs the work start signal to the display controller 3; and processing 203 is executed.

In the processing 203, the display controller 3 determines whether or not the information that is being displayed or is to be displayed by the display unit 4 is the content of the work indicated by the work state signal S2 input from the signal processor 2. In other words, the display controller 3 determines whether or not the information of the image displayed by the display unit 4 includes the information of the work corresponding to the input signal S1.

The processing ends in the case where the image information of the display image is not the information of the work indicated by the work state signal S2 input from the signal processor 2. Processing 204 is executed in the case where the image information of the display image includes the information of the work indicated by the work state signal S2 input from the signal processor 2.

In the processing 204, the visibility is reduced for the information to be displayed or for the information already displayed. In other words, in the processing 204, the display controller 3 reduces the visibility of at least a part of the image displayed by the display unit 4. For example, the display controller 3 controls the display 41 so as to reduce the visibility.

As the method for reducing the visibility, for example, it may be considered to turn the display itself OFF (not display the image corresponding to the input information D1 in the display unit 4), reduce the luminance of the display, reduce the luminance value of the display image, move the position of the display image away from the line of sight of the user 70, turn a lighted part of the display OFF (perform a non-display at a part of the image corresponding to the input information D1), reduce the luminance of a part of the display, reduce the luminance value of a part of the display image, switch the display image to an image having low visibility, etc.

Here, the reason that the visibility decreases when the luminance of the display image is reduced is because the display unit 4 is a transmission-type and the transmittance of the display image increases when the luminance of the display image is reduced.

The examples of the methods for reducing the visibility described above are merely examples; and methods other than those recited above may be used if the method reduces the visibility of the display.

As described above, for example, when the display 41 is emitting the image light L1, the signal processor 2 receives the signal (the input signal S1) relating to the subsequent action performed by the user and transmits the signal (the work state signal S2) relating to the action to the display controller 3. When the information of the image included in the image light L1 includes the information instructing the user to perform the subsequent action, and when the signal processor 2 receives the signal relating to the subsequent action of the user, the display controller 3 reduces the visibility of at least a part of the image displayed by the display unit 4.

That is, for example, the signal processor 2 receives the input signal S1 (the first signal) representing an action of the user while the display 41 is emitting the image light L1. At this time, if the image light L1 includes the information relating to the action represented by the input signal, the display controller 3 reduces the visibility of at least a part of the image displayed by the display 41.

As described in the description of the display unit 4, the display unit 4 is an optical see-through type. Therefore, the display image is displayed so that the display image and the work space 80 overlap. Therefore, if the visibility of the display is reduced, the actual view (the work space 80 which is the background of the display image) is easier to view.

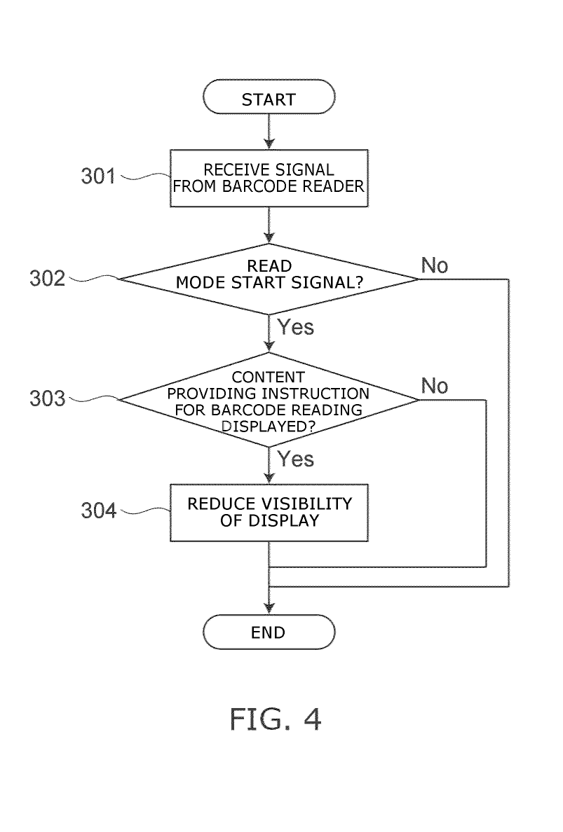

The case where the work performed by the user 70 is barcode reading work will now be described with reference to FIG. 4 as a more specific example of the processing. FIG. 4 is a flowchart illustrating the processing of the display device according to the embodiment.

In the example, the external device 15 is a barcode reader.

In processing 301 as shown in FIG. 4, the signal processor 2 receives, as the input signal S1, a signal from the barcode reader used by the user 70 wearing the head mounted display unit 4.

Subsequently, in processing 302, the signal processor 2 determines whether or not the received input signal S1 is the signal indicating the start of the work. In other words, the signal processor 2 determines whether or not the signal received from the barcode reader is a signal indicating the start of the barcode read mode.

In the case where the signal received from the barcode reader does not indicate that the barcode read mode has started, the input signal S1 does not indicate the start of the work. In such a case, the processing ends.

In the case where the signal received from the barcode reader indicates that the barcode read mode has started, the signal processor 2 determines that the barcode reading work has started. Then, processing 303 is executed.

In the processing 303, the display controller 3 determines whether or not the display unit 4 is displaying the information providing an instruction for the reading of the barcode. In the case where the display unit 4 is not displaying the information providing the instruction for the barcode reading, the processing ends. On the other hand, in the case where the display unit 4 is displaying the information providing the instruction for the barcode reading, processing 304 is executed.

In the processing 304, the display controller 3 performs processing similar to the processing of reducing the visibility of the display of the processing 204; and the processing ends.

For example, in a warehouse logistics system, etc., information such as the position of a product, a product name, etc., is displayed in front of the eye of the user using an eyeglasses-type or head mounted see-through type display device. Thereby, the work efficiency of work such as reading the barcode of the product, etc., can be increased.

However, when the information is displayed constantly in the line of sight of the user, the actual view may not be easy to view when reading the barcode. Conversely, in the display device 1 according to the embodiment, when the display 41 is emitting the image light L1, and when the signal processor 2 receives the signal relating to the subsequent action of the user from the external device, the display controller 3 reduces the visibility of the image displayed by the display unit 4. In other words, the display controller 3 performs a control relating to the display operation such as switching between the display and non-display of the image, modifying the display operation form, etc., based on the information of the external environment.

For example, a signal obtained from the barcode reader is used as the external environment information; and the display is turned OFF when the barcode reader is in the read mode. Thereby, the actual view can be easy to view. Thereby, the state of the work of aligning the barcode with the laser guide of the barcode reader or the like which is the actual view is easier to view; and it is possible to perform the work without stress.

On the other hand, in the case where the display control is performed based on the external conditions, if the control of turning the display OFF for easier viewing of the actual view is performed when the signal to start the barcode reading is received from the barcode reader, the display may be turned OFF undesirably regardless of the content displayed in the display device. For example, there are cases where necessary or important information that is unrelated to the barcode reading work such as a disaster alert, an error notification such as a mistaken location of the product shelf, etc., cannot be viewed.

Conversely, in the display device 1 according to the embodiment, the display controller 3 reduces the visibility of the image when the image information of the image displayed by the display unit 4 includes the information of the work corresponding to the input signal S1. Therefore, the visibility of the image may not be reduced when the image information of the image displayed by the display unit 4 does not include the information of the work corresponding to the input signal S1. Accordingly, for example, it is possible to not turn OFF the display of information that is desirable to be viewed but is unrelated to the work being performed by the user 70. Thereby, unnoticed information can be suppressed.

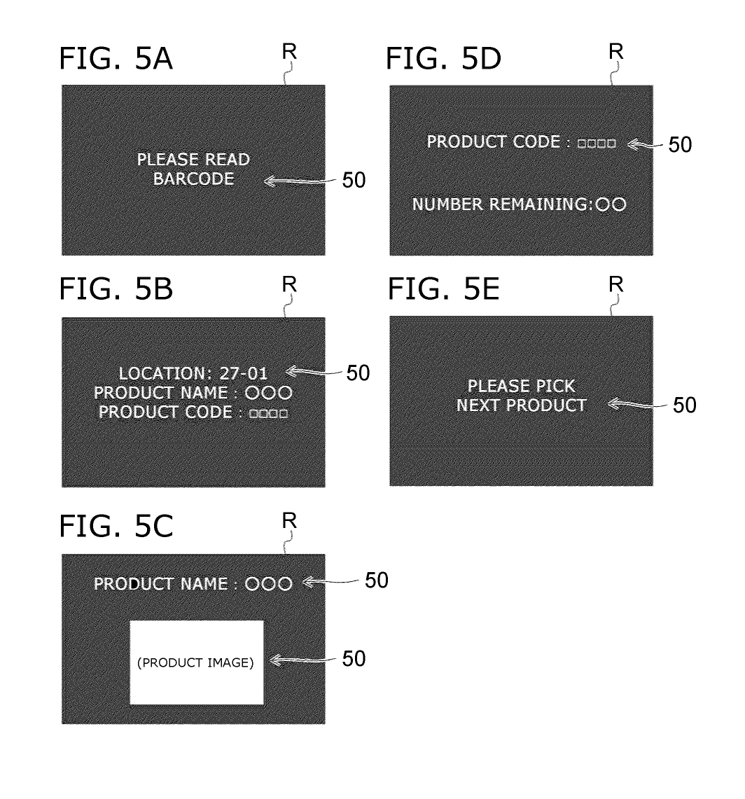

An example of the display of information providing instructions for work will now be described for the case where the work is barcode reading work. FIG. 5A to FIG. 5E are schematic views illustrating the image displayed by the display device according to the embodiment.

The image displayed by the display unit 4 includes a display object 50 disposed inside an image region R. The image region R is a region where the display unit 4 can dispose the display object 50. In the example of the display shown in the figures, the image region R is shown as a black region. The display object 50 is, for example, an image of text and/or an image of a product.

As in FIG. 5A, the display image may provide the instruction for the work of “Please read barcode” using a text display. As in FIG. 5B, the display image may provide information of the product for the barcode reading. As in FIG. 5C, the display image may provide an image of the product name and/or product of the barcode reading. As in FIG. 5D, the display image may display the product code for the barcode reading and/or a number indicating how many more products for barcode reading. As in FIG. 5E, for example, the display image may be an instruction of picking which is work that includes barcode reading work.

The information providing instructions for the work is not limited to the examples described above and may be any information that provides an instruction for the barcode reading. When such information is presented, the display controller 3 reduces the visibility of at least a part of the display image when the barcode reading work is started. Thereby, the reading work of the actual view can be easy to view.

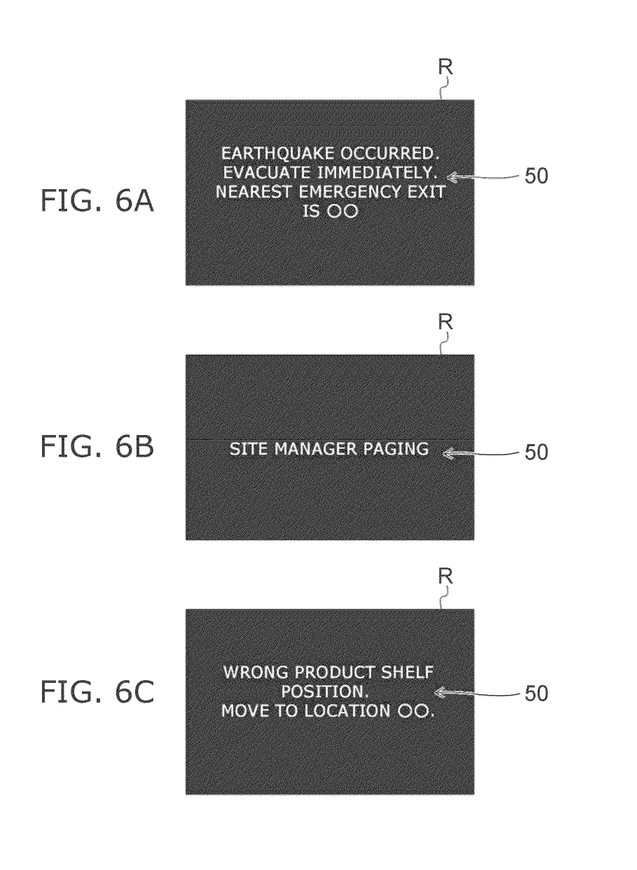

On the other hand, examples of the display of information that is not the information providing the instruction for the work in the case where the work is the barcode reading work are shown in FIG. 6A to FIG. 6C. FIG. 6A to FIG. 6C are schematic views illustrating the image displayed by the display device according to the embodiment.

For example, as in FIG. 6A, information alerting that a disaster has occurred, etc., is unrelated to the barcode reading work but is information that must be noticed. As in FIG. 6B, information of a communication from a site manager, etc., is unrelated to the barcode reading work but is information that must be noticed. As in FIG. 6C, information notifying an error such as a wrong location, etc., is unrelated to the reading work but is information that must be noticed. The information is not limited to these examples; and unnoticed important information can be suppressed by not reducing the visibility of the image corresponding to the information if the information is unrelated to the barcode reading work.

The display image may simultaneously include the information providing the instruction for the work and the information not providing the instruction for the work. In such a case, the visibility of the entire display image may be reduced; or the visibility of a part corresponding to the information providing the instruction for the work may be reduced.

An example of a display will now be described in which the visibility is reduced in the processing 204 and the processing 304.

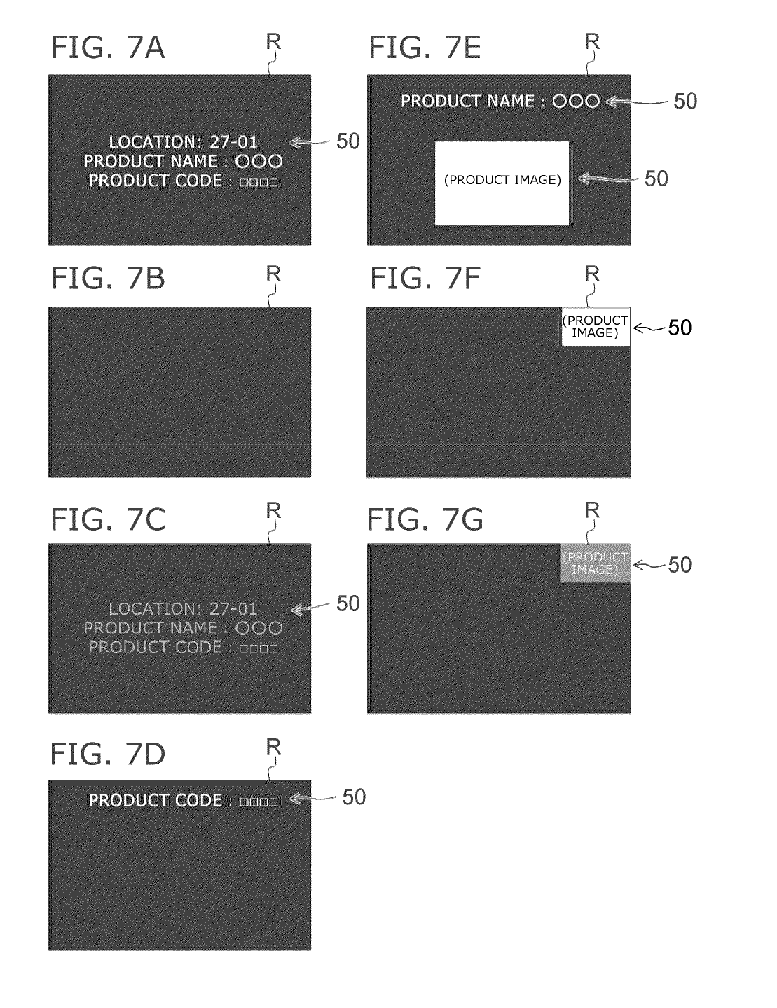

FIG. 7A to FIG. 7G are schematic views illustrating the image displayed by the display device according to the embodiment.

FIG. 7A shows the display image prior to the display controller 3 reducing the luminance. FIG. 7A is an example in which the information relating to the barcode reading work is presented. In such a case, when the barcode reading is started, for example, the luminance of the entire display may be set to 0 or an extremely low value as in FIG. 7B in the processing 204 and the processing 304. Thus, the display controller 3 reduces the luminance of at least a part of the image (e.g., the display object 50); or at least a part of the image is not displayed by the display unit 4. Thereby, the transmissivity of the display increases; and as a result, it can be easy to view the actual view. Not only can the luminance be reduced, but also the display itself can be turned OFF.

For example, as shown in FIG. 7C, the luminance of the display may be reduced. Thereby, the transmittance of the display providing the instruction for the work increases; the actual view is easier to view; and it is possible to view the work instruction.

For example, as shown in FIG. 7D, it is also possible to display the information of a part of the work instruction at an edge of the display and turn the display OFF or reduce the luminance for the remaining part. In other words, the display controller 3 may move a part of the display object 50 inside the image region R. The display controller 3 may reduce the luminance of a part of the display object 50 inside the display image. Thereby, the user 70 can obtain an easily-viewable actual view while confirming the information of the work which is displayed small at the edge of the visual field.

FIG. 7E shows another display image prior to the display controller 3 reducing the luminance. In the example in which the information providing the work instruction is displayed such as that shown in FIG. 7E, for example, the image that indicates the product is displayed small at the screen edge (the edge of the image region R) as shown in FIG. 7F; and the display is turned OFF or the luminance of the display is reduced for the remaining display. In other words, the position and size of at least a part of the image may be modified. As shown in FIG. 7G, it is also possible to make the actual view easier to view by reducing the luminance of the image.

Also, the display controller 3 may modify the color of at least a part of the image. For example, the color may be set to a color having a low visibility to match the background. Or, the luminance of the display may be set to be low at the inner part of the image region R without reducing the luminance at the outer part of the image region R.

For example, the processing of reducing the visibility described above is performed by controlling the image light L1 emitted from the display 41. For example, the luminance of the image may be modified by the brightness of the image light L1 emitted from the display 41. Other than controlling the operation of the display 41, the processing of reducing the visibility may be performed by controlling the operations of the projector 42 and the reflector 43.

The method for reducing the visibility is not limited to the display examples described above. For example, the entire display may be moved outside the visual field of the user 70. For example, the position of the image region R with respect to the user 70 may be moved by moving the projector 42 and/or the reflector 43 of the display unit 4. The visibility may be reduced by a control such as reducing the reflectance or increasing the transmittance for the reflector 43 of the display unit 4. Any method may be used as the method for reducing the visibility of the display.

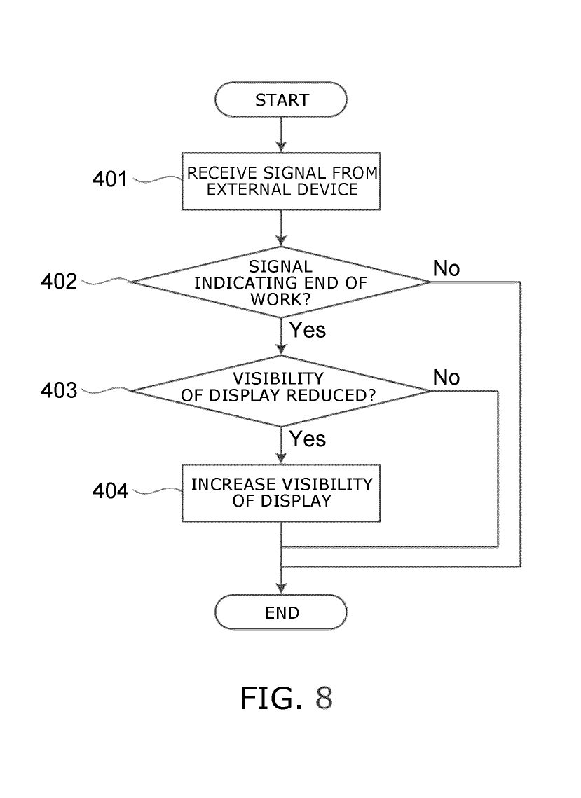

The processing of the signal processor 2 and the display controller 3 when the work ends when the display device 1 is performing the display with the reduced visibility will now be described with reference to FIG. 8. FIG. 8 is a flowchart illustrating the processing of the display device according to the embodiment.

First, in processing 401, the signal processor 2 receives a signal from the external device.

Subsequently, in processing 402, the signal processor 2 determines whether or not the signal received in the processing 401 is a signal (a second signal) indicating the end of the work. For example, in the case of the barcode reading work, examples of the work end signal include a signal that the reading of the barcode has ended, a signal that the barcode read mode has been turned OFF, etc.

The processing ends in the case where the signal received in the processing 401 is not a signal indicating the work end. In the case where the signal received in the processing 401 is the signal indicating the work end, the signal processor 2 outputs the work end signal to the display controller 3 as the work state signal S2. Then, processing 403 is executed.

The processing 403 determines whether or not the display controller 3 has reduced the visibility of the display. In the case where the display controller 3 is not reducing the visibility of the display, the display controller 3 ends the processing. In the case where the display controller 3 has reduced the visibility of the display, processing 404 is executed.

In the processing 404, the visibility of at least a part of the display image is increased. For example, in the case where the display is OFF, the display controller 3 may turn the display ON; and in the case where the luminance is reduced, the display controller 3 may perform processing to return the luminance to the original luminance. In the case where the display is moved, processing may be performed to return the display to the original position. The information indicating that the work has ended may be presented when increasing the visibility. The display controller 3 may cause the display unit 4 to display an image including information relating to the next action performed by the user. For example, the next work instruction may be presented when increasing the visibility. For example, the reflectance may be increased or the transmittance may be reduced for the reflector 43 of the display. The method for increasing the visibility is not limited to the examples described above.

In the embodiment as described above, when the user that performs work while wearing the head mounted display device performs work according to a work instruction displayed as a transmission image in front of the eye, the start of the work is detected; and the visibility of the display is reduced. Thereby, the actual work can be easy to view.

On the other hand, for example, the display controller 3 reduces the visibility of the display only when the instruction of the work is displayed. For example, the display controller 3 does not reduce the visibility of the display when displaying important information that is unrelated to the work such as evacuation instructions during a disaster, communications from the manager, information notifying a work error, etc. Thereby, it is possible for the user not to overlook the important information that is different from the content of the work.

In the embodiment, each of the blocks included in the information processor 5 may include a calculator including a CPU (Central processing Unit), memory, etc., and may include an electronic circuit as described above. Each block may include an individual circuit; or a circuit in which some or all of the blocks are integrated may be used. The blocks may be provided as one body; or some blocks may be provided separately. Also, for each block, a portion of the block may be provided separately.

In the embodiment, the processing performed by the information processor 5 may be a program executed by a computer. In other words, the information processor 5 may include a computer as the basic hardware. The processing of each of the blocks included in the information processor 5 may be implemented by causing a processor mounted in the computer to execute the program.

The program that is executed by the information processor 5 may be provided by being stored on a computer connected to a network such as the Internet, etc., and by being downloaded via the network. The program that is executed by the information processor 5 may be provided or distributed via a network such as the Internet, etc. The program that is executed by the information processor 5 may be provided by being pre-embedded in a nonvolatile recording medium such as ROM, etc.

According to the embodiment, a display device, an information processor, and an image processing method can be provided to provide an easily-viewable display for work.

Hereinabove, embodiments of the invention are described with reference to specific examples. However, the invention is not limited to these specific examples. For example, one skilled in the art may similarly practice the invention by appropriately selecting specific configurations of components such as the display, the reflector, the display unit, the signal processor, the display controller, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all display devices, information processors, and image processing methods practicable by an appropriate design modification by one skilled in the art based on the display devices, the information processors, the image processing methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device to be mounted on a head of a user, comprising:
a display to emit an image light including information of an image;
a reflector to reflect at least a part of the image light toward an eye of the user, the reflector being semi-transmissive; and
a processor to control the display so as to reduce visibility of at least a part of the image when the processor receives a first signal while the display is emitting the image light, the first signal representing an action of the user in use.

2. The device according to claim 1, wherein the action includes work to read information of an object.

3. The device according to claim 2, wherein the work includes scanning at least one of a one-dimensional code, a two-dimensional code, a RFID, or a character.

4. The device according to claim 1, wherein
the image includes an instruction for performing the action; and
the first signal indicates a start of the action of the user.

5. The device according to claim 1, wherein the processor performs increasing the visibility, when receiving a second signal indicating an action of the user after reducing the visibility.

6. The device according to claim 1, wherein the processor controls the display to display the image including information relating to work to be performed by the user, when the processor receives a second signal indicating an action of the user after reducing the visibility.

7. The device according to claim 1, wherein the processor reduces a luminance of the part of the image.

8. The device according to claim 1, wherein the processor does not display the part of the image.

9. The device according to claim 1, wherein the processor moves a position of the part of the image inside an image region where the image is displayed.

10. The device according to claim 1, wherein the processing device modifies a color of the part of the image.

11. The device according to claim 1, wherein the processor modifies a size of the part of the image.

12. An information processor, comprising:
a signal processor; and
a display controller to control a display so as to reduce visibility of at least a part of an image when the signal processor receives a first signal while the display of a display device is emitting image light including information of the image, the display device being mountable to a head of a user and including the display and a reflector to reflect at least a part of the image light toward an eye of the user, the reflector being semi-transmissive, the first signal representing an action of the user in use.

13. The information processor according to claim 12, wherein the action includes work to read information of an object.

14. The information processor according to claim 12, wherein
the image includes an instruction for performing the action, and
the first signal indicates a start of the action of the user.

15. The information processor according to claim 12, wherein the display controller performs increasing the visibility, when receiving a second signal indicating an action of the user after reducing the visibility.

16. The information processor according to claim 12 wherein the display controller controls the display to display the image including information relating to work to be performed by the user, when the display controller receives a second signal indicating an action of the user after reducing the visibility.

17. The information processor according to claim 12, wherein the display controller reduces a luminance of the part of the image.

18. An image processing method, comprising:
receiving a first signal while a display of a display device is emitting image light including information of an image, the display device being mountable to a head of a user and including the display and a reflector to reflect at least a part of the image light toward an eye of the user, the reflector being semi-transmissive, the first signal representing an action of the user in use; and
controlling the display so as to reduce visibility of at least a part of the image when the first signal is received.
